(19) United States
(12) Patent Application Publication
(10) Pub. No.: US 2026/0104691 A1
(43) Pub. Date: Apr. 16, 2026

(54) DIE SYSTEM, PARAMETER DEBUGGING METHOD AND DEVICE

(71) Applicant: SAIC GM Wuling Automobile Co., Ltd., Liuzhou (CN)

(72) Inventors: Wei WEI, Liuzhou (CN); Zuoping Yao, Liuzhou (CN); Chuntai Liu, Liuzhou (CN); Juncheng LV, Liuzhou (CN); Huimei Wu, Liuxhou (CN); Yingjuan Zhou, Liuzhou (CN); Ming Huang, Liuzhou (CN); Lina Wang, Liuzhou (CN); Feng Zhang, Liuzhou (CN); Jing Zhao, Liuzhou (CN)

(73) Assignee: SAIC GM Wuling Automobile Co., Ltd., Liuzhou (CN)

(21) Appl. No.: 19/195,378

(22) Filed: Apr. 30, 2025

Related U.S. Application Data
(63) Continuation of application No. PCT/CN2025/076958, filed on Feb. 12, 2025.

(30) Foreign Application Priority Data
Oct. 15, 2024 (CN) 202411440964.8

(51) Int. Cl. G05B 19/418

(52) U.S. Cl. CPC G05B 19/4184; G05B 19/41845

(57) ABSTRACT

Provided is a die system, and a parameter debugging method and device. The method includes: acquiring measured values of a plurality of key parameters of the die system; determining deviations between the measured values and theoretical values of the plurality of key parameters; determining, according to the deviations of the plurality of key parameters, correlational impact values of the plurality of key parameters on stable production; determining, according to the correlational impact values, whether to trigger parameter debugging on the die system; selecting, in response to a determination to trigger parameter debugging on the die system, a target key parameter from the plurality of key parameters; and performing parameter debugging on the target key parameter. According to embodiments of the present disclosure, parameters can be debugged according to impacts of superimposition of the key parameters on stable production, which provides a reasonable basis for parameter debugging and improves debugging efficiency.

### CROSS-REFERENCE TO RELATED APPLICATIONS

The present application is a continuation of International Application No. PCT/CN2025/076958, filed on Feb. 12, 2025, which claims priority to Chinese Patent Application No. 202411440964.8, filed on Oct. 15, 2024, the entire contents of which are incorporated herein by reference.

### TECHNICAL FIELD

The present disclosure relates to the field of intelligent control technologies, and in particular, to a die system, and a parameter debugging method and device.

### BACKGROUND

A conventional manner of debugging a die system is to debug relevant parameters of a die, a stamping device, or production materials. Each debugging process shall be performed slowly step by step to reach a balance point of the parameters in production, so as to achieve a stable production. However, debugging parameters slowly step by step may cause a lot of waste of resources, such as personnel, equipment, raw materials, water, electricity, and space, and may also cause a waste of debugging time. In addition, it is difficult to determine whether the parameters are reasonable after debugging. Therefore, how to efficiently debug parameters of the die system has become a technical problem to be solved.

### SUMMARY

In view of this, embodiments of the present disclosure provide a die system, and a parameter debugging method and device, so that parameters can be debugged according to impacts of superimposition of the key parameters on stable production, which provides a reasonable basis for parameter debugging and improves debugging efficiency.

In a first aspect, an embodiment of the present disclosure provides a parameter debugging method for a die system, including: acquiring measured values of a plurality of key parameters of the die system; determining deviations between the measured values and theoretical values of the plurality of key parameters; determining, according to the deviations of the plurality of key parameters, correlational impact values of the plurality of key parameters on stable production; determining, according to the correlational impact values, whether to trigger parameter debugging on the die system; selecting, in response to a determination to trigger parameter debugging on the die system, a target key parameter from the plurality of key parameters; and performing parameter debugging on the target key parameter.

In some embodiments, the determining deviations between the measured values and theoretical values of the plurality of key parameters includes: determining differences between the theoretical values and the measured values of the plurality of key parameters respectively; and determining difference ratios of the plurality of key parameters respectively according to ratios of the differences of the plurality of key parameters to the corresponding theoretical values. The difference ratios are configured to represent the deviations between the measured values and the theoretical values of the key parameters.

In some embodiments, the determining correlational impact values of the plurality of key parameters on stable production according to the deviations of the plurality of key parameters includes: weighting the difference ratios of the plurality of key parameters to obtain the correlational impact values.

In some embodiments, determining, according to the correlational impact values, whether to trigger parameter debugging on the die system includes: determining, in response to the correlational impact values being greater than a first set value, to trigger parameter debugging on the die system.

In some embodiments, the selecting, in response to a determination to trigger parameter debugging on the die system, a target key parameter from the plurality of key parameters includes: selecting a key parameter with a deviation within a preset debugging range as the target key parameter.

In some embodiments, the performing parameter debugging on the target key parameter includes: determining a parameter adjustment amount and an adjustment direction according to a difference between a theoretical value and a measured value of the target key parameter; and performing parameter debugging on the target key parameter according to the parameter adjustment amount and the adjustment direction. The parameter adjustment amount is less than an absolute value of the difference between the theoretical value and the measured value of the target key parameter, and the adjustment direction approaches the theoretical value of the target key parameter.

In some embodiments, the determining a parameter adjustment amount according to a difference between a theoretical value and a measured value of the target key parameter includes: determining a first adjustment amount in response to the absolute value of the difference between the theoretical value and the measured value of the target key parameter being greater than a second set value; adjusting the target key parameter according to a direction in which the first adjustment amount approaches the theoretical value, an absolute value of a difference between a value of the adjusted target key parameter and the theoretical value is the second set value; and continuously adjusting the target key parameter for multiple times based on the second set value until the absolute value of the difference between the target key parameter and the theoretical value is less than a third set value.

In some embodiments, the continuously adjusting the target key parameter multiple times based on the second set value until the absolute value of the difference between the target key parameter and the theoretical value is less than a third set value includes: determining a second adjustment amount according to the second set value and a number of steps; adjusting the target key parameter according to a direction in which the second adjustment amount approaches the theoretical value; and determining whether an absolute value of a difference between the adjusted target key parameter and the theoretical value is less than the third set value; if yes, stop adjusting the target key parameter; and if not, determining a third adjustment amount and continuously adjusting the target key parameter according to the absolute value of the difference between the adjusted target key parameter and the theoretical value and the number of steps until the absolute value of the difference between the target key parameter and the theoretical value is less than the third set value.

In some embodiments, the method further includes: adjusting, in response to the absolute value of the difference between the theoretical value and the measured value of the target key parameter being less than or equal to the second set value, the target key parameter for multiple times according to the absolute value of the difference between the theoretical value and the measured value of the target key parameter and the number of steps until the absolute value of the difference between the target key parameter and the theoretical value is less than the third set value.

In some embodiments, prior to the determining, according to the correlational impact values, whether to trigger parameter debugging on the die system, the method further includes: separately debugging the plurality of key parameters, so that absolute values of differences between theoretical values of separately debugged key parameters and the measured values are each less than a fourth set value.

In a second aspect, an embodiment of the present disclosure provides a control device, including: at least one processor; and at least one memory communicatively connected to the processor, the memory stores program instructions executable by the processor, and the processor calls the program instructions to perform the method in the first aspect or in any of the embodiments in the first aspect.

In a third aspect, an embodiment of the present disclosure provides a die system, including: a die device; a sensing component configured to collect measured values of a plurality of key parameters of the die device in the die system; and a control device configured to receive the measured values of the plurality of key parameters and perform the method in the first aspect or in any of the embodiments in the first aspect based on the measured values of the plurality of key parameters.

In a fourth aspect, an embodiment of the present disclosure provides a non-transitory computer-readable storage medium, the computer-readable storage medium includes a stored program, when the program is run, controls a device where the computer-readable storage medium is located to perform the method in the first aspect or in any of the embodiments in the first aspect.

The die system and the parameter debugging method and device in the embodiments of the present disclosure achieve at least the following beneficial effects.

According to the embodiments of the present disclosure, after the measured values of the key parameters are acquired, the deviations between the measured values and the theoretical values of the key parameters are determined, and correlational impacts of the key parameters on stable production can be determined according to the deviations of the key parameters. According to the correlational impacts, whether to perform parameter debugging and which key parameters are to be debugged can be determined, thereby providing a basis for parameter debugging. According to the method in the embodiments of the present disclosure, there is no need to blindly try to debug each parameter, which prevents a waste caused by debugging of each parameter, reduces debugging time, and improves debugging efficiency.

### BRIEF DESCRIPTION OF DRAWINGS

In order to more clearly illustrate the technical solutions in embodiments of the present disclosure, the accompanying drawings used in the description of the embodiments will be briefly introduced below. It is apparent that the accompanying drawings in the following description are only some embodiments of the present disclosure, and other drawings can be obtained by those of ordinary skill in the art from the provided drawings without creative efforts.

FIG. 1 is a schematic diagram of a die system according to an embodiment of the present disclosure;

FIG. 2 is a flowchart of a method for debugging key parameters of a die system according to an embodiment of the present disclosure;

FIG. 3 is a flowchart of a method for performing parameter debugging according to correlations between key parameters according to an embodiment of the present disclosure;

FIG. 4 is a schematic structural diagram of a control device according to an embodiment of the present disclosure; and

FIG. 5 is a schematic structural diagram of a control device according to an embodiment of the present disclosure.

### DESCRIPTION OF EMBODIMENTS

In order to better understand the technical solutions of the present disclosure, embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without creative efforts fall within the scope of protection of the present disclosure.

The terms used in the embodiments of the present disclosure are only for a purpose of describing specific embodiments and are not intended to limit the present disclosure. As used in the embodiments of the present disclosure and the appended claims, the singular forms of “a/an”, “said”, and “the” are intended to include plural forms, unless otherwise clearly indicated in the context.

It should be understood that the term “and/or” used herein is merely an association relationship describing associated objects, indicating that three relationships may exist. For example, A and/or B may indicate that there are three cases of A alone, A and B together, and B alone. In addition, the character “/” herein generally indicates an “or” relationship between the associated objects.

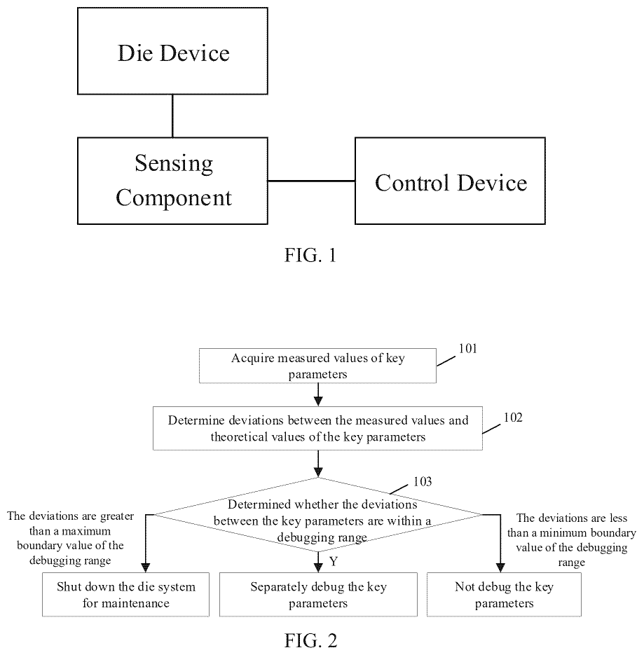

Refer to FIG. 1 which is a schematic diagram of a die system according to an embodiment of the present disclosure. The die system shown in FIG. 1 may be a die system for a vehicle production line. As shown in FIG. 1, the die system includes a die device, a sensing component, and a control device. The die device may include a product die, a stamping device, and the like. The sensing component is arranged on the die device and is configured to collect measured values of key parameters of the product die and/or the stamping device. The sensing component transmits the measured values of the key parameters of the product die and/or the stamping device to the control device. The control device performs a parameter debugging strategy based on the measured values of the key parameters of the product die and/or the stamping device.

After the die device is mounted to the die system shown in FIG. 1, theoretical values of production parameters of the die device are set. For example, theoretical values of various production parameters of the product die and the stamping device are set, and then the die system is run. During the operation of the die system, the sensing component may collect measured values of key parameters in the various production parameters of the product die and/or the stamping device according to a certain sampling frequency. It is inevitable that there may be deviations between theoretical values and measured values of key parameters of the die device. The deviations of the key parameters may form a parameter chain. The deviation parameter chain formed by respective key parameters may have a correlational impact on stable production of the product, which can trigger parameter debugging on the die system. The parameter debugging method in the present disclosure is described in detail below with reference to embodiments.

After the die device is mounted to the die system shown in FIG. 1, theoretical values of various production parameters of the die device are set, and then the die system is run. During the operation of the die system, the sensing component collects measured values of a plurality of key parameters of the die device. The sensing component sends the measured values of the plurality of key parameters of the die device to the control device. The control device may first separately debug the key parameters, and differences between separately debugged key parameters and the theoretical values can be maintained within a controllable range. After the key parameters are separately debugged, stable operation of the die system can be ensured to a certain extent.

Refer to FIG. 2 which is a flowchart of a method for debugging key parameters of a die system according to an embodiment of the present disclosure. As shown in FIG. 2, the method includes the following processing steps.

In 101, measured values of key parameters are acquired.

In 102, deviations between the measured values and theoretical values of the key parameters are determined.

In 103, it is determined whether the deviations between the key parameters are within a debugging range. If the deviations between the key parameters are within the debugging range, the corresponding key parameters are separately debugged. If the deviations between the key parameters are less than a minimum boundary value of the debugging range, the key parameters are not debugged. If the deviations between the key parameters are greater than a maximum boundary value of the debugging range, the die system is required to be shut down for maintenance.

The determining deviations between the measured values and theoretical values of the key parameters includes: determining differences between the theoretical values and the measured values of the key parameters; and determining difference ratios of the key parameters according to ratios of the differences to the theoretical values. The difference ratios are used to represent deviation values between the measured values and the theoretical values of the key parameters.

In an embodiment, it is set that Fs is a theoretical value of a key parameter, Fa is a measured value of the key parameter, and α is a difference ratio. Then, a calculation formula for the difference ratio of the key parameter may be:

$$α = ( Fs - Fa ) / Fs * 100 \% . \qquad Formula 1$$

When α<0.05%, the die system continues operating. Alternatively, when an absolute value of α<0.05%, the die system continues operating.

When 0.05%≤α≤0.1%, it is determined to debug the key parameters of the die system. Alternatively, when 0.05%≤ the absolute value of α≤0.1%, it is determined to debug the key parameters of the die system.

When α>0.1%, the difference ratio of the key parameter exceeds the debugging range, and the die system is controlled to be shut down for maintenance. Alternatively, when the absolute value of α>0.1%, the difference ratio of the key parameter exceeds the debugging range, and the die system is controlled to be shut down for maintenance.

In the above example, when the value of the difference ratio is in the range of [0.05%, 0.1%] or the absolute value of the difference ratio is in the range of [0.05%, 0.1%], indicating that the key parameter is within the debugging range, the key parameter may be debugged. When the difference ratio of the key parameter of the absolute value of the difference ratio is less than the minimum boundary value of the debugging range, the key parameter may not necessarily be debugged. When the difference ratio of the key parameter of the absolute value of the difference ratio is greater than the maximum boundary value of the debugging range, the die system is controlled to be shut down for maintenance.

When it is determined to debug the key parameter, to prevent damage to the die device or a waste of materials, a single adjustment amount of the key parameter should not be excessively large. The key parameter may be adjusted multiple times based on the difference between the theoretical value and the measured value of the key parameter.

In some embodiments, a parameter adjustment amount and an adjustment direction are determined according to the difference between the theoretical value and the measured value of the key parameter. Parameter adjustment is performed on the key parameter according to the parameter adjustment amount and the adjustment direction. The parameter adjustment amount is less than an absolute value of the difference between the theoretical value and the measured value of the key parameter. The adjustment direction refers to a direction approaching the theoretical value of the key parameter.

The determining a parameter adjustment amount according to the difference between the theoretical value and the measured value of the key parameter includes: determining a first adjustment amount if the absolute value of the difference between the theoretical value and the measured value of the key parameter is greater than a second set value; adjusting the key parameter according to a direction in which the first adjustment amount approaches the theoretical value, and an absolute value of a difference between a value after adjustment of the key parameter and the theoretical value is the second set value; and continuously adjusting the target key parameter multiple times based on the second set value until the absolute value of the difference between the key parameter and the theoretical value is less than a third set value.

The continuously adjusting the key parameter multiple times based on the second set value until the absolute value of the difference between the key parameter and the theoretical value is less than a third set value includes: determining a second adjustment amount according to the second set value and a number of steps; adjusting the key parameter according to a direction in which the second adjustment amount approaches the theoretical value; determining whether an absolute value of a difference between an adjusted key parameter and the theoretical value is less than the third set value; if yes, stop adjusting the key parameter; and if not, determining a third adjustment amount and continuously adjusting the key parameter according to the absolute value of the difference between the adjusted key parameter and the theoretical value and the number of steps until the absolute value of the difference between the key parameter and the theoretical value is less than the third set value.

If the absolute value of the difference between the theoretical value and the measured value of the key parameter is less than or equal to the second set value, the key parameter is adjusted multiple times according to the absolute value of the difference between the theoretical value and the measured value of the key parameter and the number of steps until the absolute value of the difference between the key parameter and the theoretical value is less than the third set value. It is to be noted that the third set value is a preset certain value, which may alternatively be referred to as a fourth set value, a fifth set value, or the like in different scenarios for convenience of description.

In an embodiment, when the absolute value of the difference between the theoretical value and the measured value of the key parameter is less than or equal to the second set value, a single adjustment amount an of the key parameter may be determined according to Formula 2.

$$α n = ( Fs - Fa ) / n . \qquad Formula 2$$

In Formula 2, n may be a fixed value, an represents the single adjustment amount of the key parameter, and positive and negative values of an represent the adjustment direction of the key parameter. When αn is positive, indicating that the measured value of the key parameter is less than the theoretical value, the key parameter is required to be adjusted to increase. When an is negative, indicating that the measured value of the key parameter is greater than the theoretical value, the key parameter is required to be adjusted to decrease.

In some embodiments, a plurality of key parameters of the die system include: one or more of a production tonnage size (a), production cycle time (b), an air cushion size (c), material inflow (d), a die closing height (e), a die temperature (f), and die wear (g). Those skilled in the art may obtain other parameters according to the listed parameters. Debugging methods for the other parameters may be obtained with reference to the debugging method for the listed parameters.

In some embodiments, debugging on the key parameters includes: production tonnage size (a): increase or decrease output tonnage of the device; production cycle time (b): decrease or increase the cycle time; air cushion size (c): increase or decrease a size of an air cushion output pressure source; material inflow (d): increase or decrease material usage; die closing height (e): decrease or increase the closing height; die temperature (f): increase or decrease a flow rate of a cooling medium to decrease or increase the die temperature; and die wear (g): increase or decrease magnitude of a frictional force.

### Example I

A theoretical value of the die closing height is 1000 mm. The closing height changes slightly during production, resulting in decrease of the closing height to 999 mm. In this case, a manufactured product has cracking defects, the difference ratio is α=(1000−999)/1000=0.1%, and the value of α is within the debugging range. The control device debugs the die closing height as follows:

In situation I, a difference between a theoretical value and a measured value of the die closing height is 1 mm, which is 2 mm less than a set value. Then, the die closing height is debugged multiple times in the following manner:

If the difference between the theoretical value and the measured value of the die closing height is 1 mm, that is, if a total adjustment value is 1 mm, and the number of steps is n=5, the adjustment amount each time is:

The first adjustment amount is α1=(1000−999)/5=0.2 mm;

The second adjustment amount is α2=(1000−999.2)/5=0.16 mm; and

The third adjustment amount is α3=(1000−999.36)/5=0.128 mm.

When an absolute value of a difference between an adjusted die closing height and the theoretical value, i.e., the total adjustment value, is less than 0.1 mm, the adjustment to the die closing height is stopped.

In situation II, if the difference between the theoretical value and the measured value of the die closing height is 2 mm greater than the set value, quick adjustment on the die closing height is allowed. An absolute value of a difference between a die closing height after quick adjustment and the theoretical value is 2 mm. Then, the die closing height is adjusted multiple times according to the situation I.

In situation III, if the theoretical value of the die closing height is less than the measured value, for example, the theoretical value is 1000 mm and the measured value is 1001 mm, the adjustment direction is opposite to the above adjustment direction in situations I and II.

### Example II

A theoretical value of the production tonnage is 2000 tons, and the measured value is 1800 tons. An insufficient pressure value may cause corrugation or lamination of the product. In this case, the difference ratio α=(2000−1800)/2000=10%. In this case, the system should be shut down for maintenance. If the measured value is 1998 tons, the difference ratio α=(2000−1998)/2000=0.1%. In this case, parameter debugging is performed on the production tonnage according to Formula 2. The debugging method may refer to Example I.

After the key parameters are separately debugged so that the absolute values of the differences between the key parameters and the theoretical values are all within the third set value (also called a certain value), the control device may superimpose the key parameters to calculate correlations between the key parameters, thereby debugging the die system according to the correlations between the key parameters.

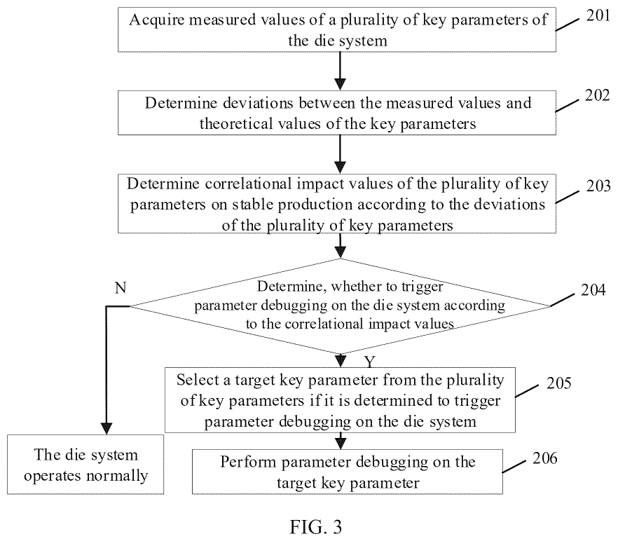

Refer to FIG. 3 which is a flowchart of a method for performing parameter debugging according to correlations between key parameters according to an embodiment of the present disclosure. As shown in FIG. 3, the method includes the following processing steps.

In 201, measured values of a plurality of key parameters of the die system are acquired.

In 202, deviations between the measured values and theoretical values of the key parameters are determined.

In 203, correlational impact values of the plurality of key parameters on stable production are determined according to the deviations of the plurality of key parameters.

In 204, it is determined, according to the correlational impact values, whether to trigger parameter debugging on the die system.

In 205, a target key parameter is selected from the plurality of key parameters if it is determined to trigger parameter debugging on the die system.

In 206, parameter debugging is performed on the target key parameter.

The plurality of key parameters may include: one or more of a production tonnage size (a), production cycle time (b), an air cushion size (c), material inflow (d), a die closing height (e), a die temperature (f), and die wear (g). Those skilled in the art may obtain other parameters according to the listed parameters. Debugging methods for the other parameters may be obtained with reference to the debugging method for the listed parameters.

The plurality of key parameters may have correlational impacts on the stable production of the die system. After the measured values of the plurality of key parameters are acquired, correlational impact values thereof on the stable production may be calculated according to the measured values of the plurality of key parameters.

In some embodiments, a functional relationship f (a, b, c, d, e, f, g) between correlational impact values β and the plurality of key parameters may be preset. The measured values of the plurality of key parameters, after being acquired, are substituted into the above functional relationship f (a, b, c, d, e, f, g), to obtain the correlational impact values β.

In some embodiments, the key parameters have respective theoretical values. After the measured values of the key parameters are acquired, differences between the theoretical values and the measured values of the key parameters may be determined. Difference ratios of the key parameters may be determined respectively according to ratios of the differences of the key parameters to the corresponding theoretical values. The difference ratios are used to represent the deviations between the measured values and the theoretical values of the key parameters. Refer to Formula 1 for a calculation method for the difference ratios of the key parameters.

In some embodiments, the correlational impact values of the plurality of key parameters on stable production may be obtained by weighting the difference ratios of the plurality of key parameters. In an example, the correlational impact values β may be calculated according to the following Formula 3:
Formula 3: β=a+b+c+d+e+f+g. In the above formula, a, b, c, d, e, f and g are difference ratios of key parameters (a), (b), (c), (d), (e), (f), and (g) respectively. In Formula 3, values of a, b, c, d, e, f, and g may be positive or negative.

In some embodiments, it is determined to trigger parameter debugging on the die system if the correlational impact values are greater than a first set value. For example, when β≤0.3, indicating that production of the die system is stable, there is no need to trigger parameter debugging. When β>0.3, indicating that production of the die system is unstable, there is a need to trigger parameter debugging on the die system. Optionally, after absolute values of the correlational impact values are taken, it may be determined whether the absolute values of the correlational impact values are greater than the first set value, and if yes, it is determined to trigger parameter debugging on the die system. For example, when absolute values of β≤0.3, indicating that production of the die system is stable, there is no need to trigger parameter debugging. When the absolute values of β>0.3, indicating that production of the die system is unstable, there is a need to trigger parameter debugging on the die system.

After it is determined, according to the correlational impact values β, to trigger parameter debugging on the die system, instead of debugging all the key parameters directly, a target key parameter is selected from the plurality of key parameters for debugging.

The target key parameter may be selected from the plurality of key parameters by selecting a key parameter whose deviation between the measured value and the theoretical value is within the debugging range as the target key parameter.

The difference ratios of the key parameters may be calculated according to Formula 1, and the target key parameter may be selected according to a rule corresponding to Formula 1, to debug the target key parameter.

The debugging the target key parameter includes: determining a parameter adjustment amount and an adjustment direction according to a difference between a theoretical value and a measured value of the target key parameter; and performing parameter debugging on the target key parameter according to the parameter adjustment amount and the adjustment direction. The parameter adjustment amount is less than an absolute value of the difference between the theoretical value and the measured value of the target key parameter, and the adjustment direction approaches the theoretical value of the target key parameter.

The determining a parameter adjustment amount according to a difference between a theoretical value and a measured value of the target key parameter includes: determining a first adjustment amount if the absolute value of the difference between the theoretical value and the measured value of the target key parameter is greater than a second set value; adjusting the target key parameter according to a direction in which the first adjustment amount approaches the theoretical value, an absolute value of a difference between a value after adjustment of the target key parameter and the theoretical value is the second set value; and continuously adjusting the target key parameter multiple times based on the second set value until the absolute value of the difference between the target key parameter and the theoretical value is less than a third set value.

The continuously adjusting the target key parameter multiple times based on the second set value until the absolute value of the difference between the target key parameter and the theoretical value is less than a third set value includes: determining a second adjustment amount according to the second set value and a number of steps; adjusting the target key parameter according to a direction in which the second adjustment amount approaches the theoretical value; determining whether an absolute value of a difference between an adjusted target key parameter and the theoretical value is less than the third set value; if yes, stop adjusting the target key parameter; and if not, determining a third adjustment amount and continuously adjusting the target key parameter according to the absolute value of the difference between the adjusted target key parameter and the theoretical value and the number of steps until the absolute value of the difference between the target key parameter and the theoretical value is less than the third set value.

If the absolute value of the difference between the theoretical value and the measured value of the target key parameter is less than or equal to the second set value, the target key parameter is adjusted multiple times according to the absolute value of the difference between the theoretical value and the measured value of the target key parameter and the number of steps until the absolute value of the difference between the target key parameter and the theoretical value is less than the third set value.

The debugging method of the target key parameter can refer to the foregoing description.

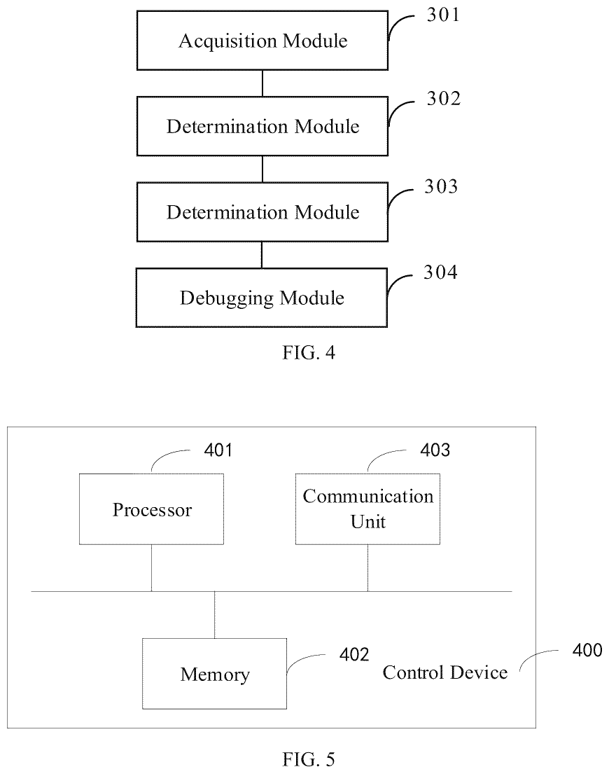

Corresponding to the parameter debugging method for a die system above, an embodiment of the present disclosure further provides a schematic structural diagram of a control device. As shown in FIG. 4, the control device includes:

An acquisition module 301 configured to acquire measured values of a plurality of key parameters of the die system;

A determination module 302 configured to determine deviations between the measured values and theoretical values of the plurality of key parameters; and determine correlational impact values of the plurality of key parameters on stable production according to the deviations of the plurality of key parameters; and

A determination module 303 configured to determine, according to the correlational impact values, whether to trigger parameter debugging on the die system; and

A debugging module 304 configured to select a target key parameter from the plurality of key parameters if it is determined to trigger parameter debugging on the die system, and perform parameter debugging on the target key parameter.

The control device in embodiments of the present disclosure may perform the parameter debugging method in the embodiments described above. For parts that are not described in detail in the device embodiments, please refer to the relevant description in the method embodiments. For the implementation process and technical effects of the technical solution, please refer to the description in the method embodiments, which are not described in detail herein again.

Refer to FIG. 5 which is a schematic structural diagram of a control device according to an embodiment of the present disclosure. The control device shown in FIG. 5 is implemented in the form of a computer. As shown in FIG. 5, the control device 400 may include: a processor 401, a memory 402, and a communication unit 403. These components communicate over one or more buses. Those skilled in the art may understand that the structure of the control device illustrated does not limit the embodiments of the present disclosure, which may be a bus structure or a star structure, and may also include more or fewer components than those illustrated, or certain components are combined, or different component arrangements are adopted.

The communication unit 403 is configured to establish a communication channel, to enable the control device to communicate with another device to receive user data sent by the other device or send user data to the other device.

The processor 401 is a control center of the control device, uses various interfaces and lines to connect various parts of the entire control device, and executes various functions of the control device and/or processes data by running or executing software programs, instructions, and/or modules stored in the memory 402 and calling data stored in the memory. The processor may be formed by an integrated circuit (IC), which may be formed by, for example, a single packaged IC or formed by connecting a plurality of packaged ICs having a same function or different functions. For example, the processor 401 may include only a central processing unit (CPU). In embodiments of the present disclosure, the CPU may be a single computing core, or may include a plurality of computing cores.

The memory 402 is configured to store execution instructions of the memory 401. The memory 402 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The execution instructions in the memory 402, when executed by the processor 401, cause the control device 400 to perform some or all of the steps of the parameter debugging method for a die system in the embodiment shown in FIG. 1.

During specific implementation, the present disclosure further provides a computer storage medium. The computer storage medium may have a program stored therein. The program, when executed, may include some or all of the steps in the embodiments of the parameter debugging method for a die system provided in the present disclosure. The storage medium may be a magnetic disk, an optical disc, a ROM, a random access memory (RAM), or the like.

During specific implementation, the present disclosure further provides a computer program product. The computer program product includes executable instructions. The executable instructions, when executed on a computer, cause the computer to perform some or all of the steps in the embodiments of the parameter debugging method for a die system provided in the present disclosure.

An embodiment of the present disclosure further provides a non-transitory computer-readable storage medium. The non-transitory computer-readable storage medium stores computer instructions. The computer instructions cause the computer to perform the method provided in the embodiments of the present disclosure.

The non-transitory computer-readable storage medium may be any combination of one or more computer-readable media. The computer-readable medium may be a computer-readable signal medium or a computer-readable storage medium. The computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include: an electrical connection having one or more wires, a portable computer diskette, a hard disk, a RAM, a ROM, an EPROM or a Flash memory, an optical fiber, a portable compact disc read-only memory (CD-ROM), an optical storage device, a magnetic storage device, or any suitable combination of the foregoing. Herein, the computer-readable storage medium may be any tangible medium that may include or store a program for use by or in connection with an instruction execution system, apparatus, or device.

The computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. The computer-readable signal medium may be any computer-readable medium that is not a computer-readable storage medium. The computer-readable medium may communicate, propagate, or transmit a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Those skilled in the art can clearly understand that the technology in the embodiments of the present disclosure can be implemented by means of software plus a necessary general hardware platform. Based on such understanding, the technical solutions in the embodiments of the present disclosure essentially or the part contributing to the prior art may be implemented in the form of a software product. The computer software product may be stored in a storage medium, such as a ROM/RAM, a magnetic disk, or an optical disc, and includes several instructions for instructing a computer device (which may be a personal computer, a server, a network device, or the like) to perform the methods described in the embodiments or some of the embodiments of the present disclosure.

The same and similar parts among the various embodiments in the present disclosure may be referred to each other. In particular, for the apparatus embodiments and the terminal embodiments, since they are basically similar to the method embodiments, the description is relatively simple. For relevant details, please refer to the description in the method embodiments.

What is claimed is:

1. A parameter debugging method for a die system, comprising:
acquiring measured values of a plurality of key parameters of the die system;
determining deviations between the measured values and theoretical values of the plurality of key parameters;
determining, according to the deviations of the plurality of key parameters, correlational impact values of the plurality of key parameters on stable production;
determining, according to the correlational impact values, whether to trigger parameter debugging on the die system;
selecting, in response to a determination to trigger parameter debugging on the die system, a target key parameter from the plurality of key parameters; and
performing parameter debugging on the target key parameter.

2. The method according to claim 1, wherein the determining deviations between the measured values and theoretical values of the plurality of key parameters comprises:
determining differences between the theoretical values and the measured values of the plurality of key parameters respectively; and
determining difference ratios of the plurality of key parameters respectively according to ratios of the differences of the plurality of key parameters to the corresponding theoretical values, wherein the difference ratios are configured to represent the deviations between the measured values and the theoretical values of the key parameters.

3. The method according to claim 2, wherein the determining, according to the deviations of the plurality of key parameters, correlational impact values of the plurality of key parameters on stable production comprises:
weighting the difference ratios of the plurality of key parameters to obtain the correlational impact values.

4. The method according to claim 1, wherein the determining, according to the correlational impact values, whether to trigger parameter debugging on the die system comprises:
determining, in response to the correlational impact values being greater than a first set value, to trigger parameter debugging on the die system.

5. The method according to claim 1, wherein the selecting, in response to a determination to trigger parameter debugging on the die system, a target key parameter from the plurality of key parameters comprises:
selecting a key parameter with a deviation within a preset debugging range as the target key parameter.

6. The method according to claim 1, wherein the performing parameter debugging on the target key parameter comprises:
determining a parameter adjustment amount and an adjustment direction according to a difference between a theoretical value and a measured value of the target key parameter; and
performing parameter debugging on the target key parameter according to the parameter adjustment amount and the adjustment direction;
wherein the parameter adjustment amount is less than an absolute value of the difference between the theoretical value and the measured value of the target key parameter, and
the adjustment direction approaches the theoretical value of the target key parameter.

7. The method according to claim 6, wherein the determining a parameter adjustment amount according to a difference between a theoretical value and a measured value of the target key parameter comprises:
determining a first adjustment amount in response to the absolute value of the difference between the theoretical value and the measured value of the target key parameter being greater than a second set value;
adjusting the target key parameter according to a direction in which the first adjustment amount approaches the theoretical value, wherein an absolute value of a difference between a value of the adjusted target key parameter and the theoretical value is the second set value; and
continuously adjusting the target key parameter for multiple times based on the second set value until the absolute value of the difference between the target key parameter and the theoretical value is less than a third set value.

8. The method according to claim 7, wherein the continuously adjusting the target key parameter for multiple times based on the second set value until the absolute value of the difference between the target key parameter and the theoretical value is less than a third set value comprises:
determining a second adjustment amount according to the second set value and a number of steps;
adjusting the target key parameter according to a direction in which the second adjustment amount approaches the theoretical value; and
determining whether an absolute value of a difference between the adjusted target key parameter and the theoretical value is less than the third set value;
if yes, stop adjusting the target key parameter; and
if not, determining a third adjustment amount and continuously adjusting the target key parameter according to the absolute value of the difference between the adjusted target key parameter and the theoretical value and the number of steps until the absolute value of the difference between the target key parameter and the theoretical value is less than the third set value.

9. The method according to claim 7, further comprising:
adjusting, in response to the absolute value of the difference between the theoretical value and the measured value of the target key parameter being less than or equal to the second set value, the target key parameter for multiple times according to the absolute value of the difference between the theoretical value and the measured value of the target key parameter and the number of steps until the absolute value of the difference between the target key parameter and the theoretical value is less than the third set value.

10. The method according to claim 5, wherein the performing parameter debugging on the target key parameter comprises:
determining a parameter adjustment amount and an adjustment direction according to a difference between a theoretical value and a measured value of the target key parameter; and
performing parameter debugging on the target key parameter according to the parameter adjustment amount and the adjustment direction;
wherein the parameter adjustment amount is less than an absolute value of the difference between the theoretical value and the measured value of the target key parameter, and
the adjustment direction approaches the theoretical value of the target key parameter.

11. The method according to claim 10, wherein the determining a parameter adjustment amount according to a difference between a theoretical value and a measured value of the target key parameter comprises:
determining a first adjustment amount in response to the absolute value of the difference between the theoretical value and the measured value of the target key parameter being greater than a second set value;
adjusting the target key parameter according to a direction in which the first adjustment amount approaches the theoretical value, wherein an absolute value of a difference between a value of the adjusted target key parameter and the theoretical value is the second set value; and
continuously adjusting the target key parameter for multiple times based on the second set value until the absolute value of the difference between the target key parameter and the theoretical value is less than a third set value.

12. The method according to claim 11, wherein the continuously adjusting the target key parameter for multiple times based on the second set value until the absolute value of the difference between the target key parameter and the theoretical value is less than a third set value comprises:
determining a second adjustment amount according to the second set value and a number of steps;
adjusting the target key parameter according to a direction in which the second adjustment amount approaches the theoretical value; and
determining whether an absolute value of a difference between the adjusted target key parameter and the theoretical value is less than the third set value;
if yes, stop adjusting the target key parameter; and
if not, determining a third adjustment amount and continuously adjusting the target key parameter according to the absolute value of the difference between the adjusted target key parameter and the theoretical value and the number of steps until the absolute value of the difference between the target key parameter and the theoretical value is less than the third set value.

13. The method according to claim 11, further comprising:
adjusting, in response to the absolute value of the difference between the theoretical value and the measured value of the target key parameter being less than or equal to the second set value, the target key parameter for multiple times according to the absolute value of the difference between the theoretical value and the measured value of the target key parameter and the number of steps until the absolute value of the difference between the target key parameter and the theoretical value is less than the third set value.

14. The method according to claim 1, wherein prior to the determining, according to the correlational impact values, whether to trigger parameter debugging on the die system, the method further comprises:
separately debugging the plurality of key parameters, so that absolute values of differences between theoretical values of separately debugged key parameters and the measured values are each less than a fourth set value.

15. A control device, comprising:
at least one processor; and
at least one memory communicatively connected to the at least one processor,
wherein the at least one memory stores program instructions executable by the at least one processor, and the at least one processor calls the program instructions to perform the method according to claim 1.

16. A non-transitory computer-readable storage medium, wherein the computer-readable storage medium comprises a stored program, wherein when the program is run, controls a device where the computer-readable storage medium is located to perform the method according to claim 1.
